(19) United States
(12) Patent Application Publication
(10) Pub. No.: US 2015/0339984 A1
(43) Pub. Date: Nov. 26, 2015

(54) LOAD EFFECT COMPENSATION SYSTEM, DISPLAY DEVICE HAVING THE SAME, AND METHOD OF COMPENSATING LOAD EFFECT OF DISPLAY PANEL

(71) Applicant: Samsung Display Co., Ltd., Yongin-City (KR)

(72) Inventor: Chang-Ho Hyun, Seoul (KR)

(21) Appl. No.: 14/522,993

(22) Filed: Oct. 24, 2014

(30) Foreign Application Priority Data
May 22, 2014 (KR) 10-2014-0061497

(51) Int. Cl. G09G 3/34; G09G 3/36; G09G 3/32

(52) U.S. Cl. CPC G09G 3/3406; G09G 3/3225; G09G 3/3648; G09G 2360/145; G09G 2310/08

(57) ABSTRACT

A load effect compensation system, display device having the same, and method of compensating load effect of display panel are disclosed. In one aspect, the load effect compensation system for a display device includes a light sensor operatively connected to a display panel and configured to detect an amount of light emitted from the display panel and a light converter configured to convert the detected amount of light into a load amount. The system also includes a data corrector configured to receive the load amount and an image signal and adjust grayscale values of the image signal based at least in part on the load amount.

### INCORPORATION BY REFERENCE TO ANY PRIORITY APPLICATIONS

This application claims priority under 35 USC §119 to Korean Patent Applications No. 10-2014-0061497, filed on May 22, 2014 in the Korean Intellectual Property Office (KIPO), the contents of which are incorporated herein in its entirety by reference.

### BACKGROUND

1. Field

The described technology generally relates to a load effect compensation system, display device having the same, and method of compensating a load effect of a display panel.

2. Description of the Related Technology

Flat panel displays (FPDs) are in wide use because they are lightweight and thin compared to cathode-ray tube (CRT) displays. Typical examples of FPDs include liquid crystal displays (LCD) and organic light-emitting diode (OLED) displays.

### SUMMARY OF CERTAIN INVENTIVE ASPECTS

One inventive aspect is a load effect compensation system capable of decreasing a capacity of memory and compensating a load effect.

Another aspect is a display device having the load effect compensation system capable of displaying a high-quality image.

Another aspect is a method of compensating a load effect of a display panel capable of decreasing a capacity of memory and compensating a load effect.

Another aspect is a load effect compensating system that can include a light sensor attached to a display panel, the light sensor configured to detect an amount of light emitted from the display panel, a light converting unit configured to convert the amount of light detected by the light sensor into a load amount, and a data correction unit configured to receive the load amount and an image signal, and to correct a grayscale value of the image signal based on the load amount.

In the above compensating system, the light converting unit can include an analog to digital converter configured to convert the amount of light detected by the light sensor into a digital signal, a line buffer configured to store the digital signal, a filter unit configured to filter the digital signal stored in the buffer, and a load amount determination unit configured to determine the load amount based on the digital signal that is filtered by the filter unit.

In the above compensating system, the load amount determination unit can determine the load amount using the lookup table that stores the load amount corresponding to the digital signal.

In the above compensating system, the light sensor can be disposed on a side of the display panel.

In the above compensating system, the light sensor can be disposed on a back surface of the display panel.

In the above compensating system, the light sensor can include a red light sensor configured to detect an amount of red light, a green light sensor configured to detect an amount of green light, and a blue light sensor configured to detect an amount of blue light.

In the above compensating system, the red light sensor can include a red color filter, the green light sensor can include a green color filter, and the blue light sensor can include a blue color filter.

Another aspect is a display device that can include a display panel, a scan driving unit configured to provide a scan signal to the display panel, a data driving unit configured to provide a data signal to the display panel, a load effect compensation system configured to detect an amount of light emitted from the display panel, to convert the detected amount of light into an load amount, and to correct a grayscale value of an image signal based on the load amount, and a timing control unit configured to control the scan driving unit, the data driving unit, and the load effect compensation system.

In the above display device, the load effect compensation system can be coupled to the timing control unit, or located in the timing control unit.

In the above display device, the load effect compensation system can include a light sensor attached to the display panel, the light sensor configured to detect the amount of light emitted from the display panel, a light converting unit configured to convert the amount of light detected by the light sensor into the load amount, and a data correction unit configured to receive the load amount and the image signal, and to correct a grayscale value of the image signal based on the load amount.

In the above display device, the light converting unit can include an analog to digital converter configured to convert the amount of light detected by the light sensor into a digital signal, a line buffer configured to store the digital signal, a filter unit configured to filter the digital signal stored in the line buffer, and a load amount determination unit configured to determine the load amount based on the digital signal that is filtered by the filter unit, and to output the load amount.

In the above display device, the load amount determination unit can determine the load amount using a lookup table that stores the load amount corresponding to the digital signal.

In the above display device, the light sensor can be disposed on a side of the display panel.

In the above display device, the light sensor can be disposed on a back surface of the display panel.

In the above display device, the light sensor can include a red light sensor configured to detect an amount of red light, a green light sensor configured to detect an amount of green light, and a blue light sensor configured to detect an amount of blue light.

In the above display device, the red light sensor can include a red color filter, the green light sensor can include a green color filter, and the blue light sensor can include a blue color filter.

Another aspect is a method of compensating a load effect of a display panel that can include detecting an amount of light emitted from the display panel using a light sensor, converting the detected amount of light into a load amount, and correcting a grayscale value of an image signal based on the load amount.

In the above method, converting the detected amount of light into the load amount can include converting the detected amount of light into a digital signal, storing the digital signal, filtering the stored digital signal, and determining the load amount based on the filtered digital signal.

In the above method, the load amount can be determined using a lookup table that stores the load amount corresponding to the digital signal.

In the above method, detecting the amount of light emitted from the display panel can include detecting an amount of red light emitted from the display panel, detecting an amount of green light emitted from the display panel, and detecting an amount of blue light emitted from the display panel.

Another aspect is a load effect compensation system for a display device comprising a light sensor operatively connected to a display panel and configured to detect an amount of light emitted from the display panel, a light converter configured to convert the detected amount of light into a load amount, and a data corrector configured to i) receive the load amount and an image signal, and ii) adjust grayscale values of the image signal based at least in part on the load amount.

In the above system, the light converter includes an analog-to-digital (A/D) converter configured to convert the detected amount of light into a digital signal, a line buffer configured to store the digital signal, a filter configured to filter the stored digital signal, and a load amount determination unit configured to determine the load amount based at least in part on the filtered digital signal.

In the above system, the load amount determination unit is further configured to determine the load amount based at least in part on a lookup table that stores the load amount corresponding to the digital signal.

In the above system, the light sensor is placed on a side of the display panel. In the above system, the light sensor is placed on a back surface of the display panel. In the above system, the light sensor includes red, green and blue light sensors respectively configured to detect amounts of red, green and blue light.

In the above system, the red, green and blue light sensors respectively include red, green and blue color filters.

Another aspect is a display device comprising a display panel configured to emit light, a scan driver configured to transmit a scan signal to the display panel, a data driver configured to transmit a data signal to the display panel, a load effect compensation system configured to i) detect an amount of the emitted light, ii) convert the detected amount of light into a load amount, and iii) adjust grayscale values of an image signal based at least in part on the load amount, and a timing controller configured to control the scan driver, the data driver, and the load effect compensation system.

In the above display device, the load effect compensation system is connected to or located in the timing controller. In the above display device, the load effect compensation system includes a light sensor attached to the display panel and configured to detect the amount of emitted light, a light converter configured to convert the detected amount of light into the load amount, and a data corrector configured to i) receive the load amount and the image signal and ii) adjust gray scale values of the image signal based at least in part on the load amount.

In the above display device, the light converter includes an analog-to-digital (A/D) converter configured to convert the detected amount of light into a digital signal, a line buffer configured to store the digital signal, a filter configured to filter the stored digital signal, and a load amount determination unit configured to determine and output the load amount based at least in part on the filtered digital signal.

In the above display device, the load amount determination unit is configured to determine the load amount based at least in part on a lookup table that stores the load amount corresponding to the digital signal.

In the above display device, the light sensor is placed on a side of the display panel. In the above display device, the light sensor is placed on a back surface of the display panel.

In the above display device, the light sensor includes red, green and blue light sensors respectively configured to detect amounts of red, green and blue light.

In the above display device, the red, green and blue light sensors respectively include red, green and blue color filters.

Another aspect is a method of compensating a load effect for a display panel, the method comprising detecting an amount of light emitted from the display panel, converting the detected amount of light into a load amount, and adjusting grayscale values of an image signal based at least in part on the load amount.

In the above method, the converting includes converting the detected amount of light into a digital signal, storing the digital signal, filtering the stored digital signal, and determining the load amount based at least in part on the filtered digital signal.

In the above method, the determining is performed based at least in part on a lookup table that stores the load amount corresponding to the digital signal.

In the above method, the detecting includes detecting amounts of red, green and blue light emitted from the display panel.

In at least one disclosed embodiment, a load effect compensation system, a display device having the load effect compensation system, and a method of compensating a load effect of a display panel can decrease a capacity of a memory that stores frame image signals to calculate a load amount of the frame image signals by converting an amount of light into the load amount. Further, an image of which load effect is compensated can be displayed by controlling a brightness of the image based on the load amount and correcting a grayscale value of the image signals.

### BRIEF DESCRIPTION OF THE DRAWINGS

FIG. 1 is a block diagram illustrating a load effect compensation system according to example embodiments.

FIG. 2 is a block diagram illustrating a light converting unit included in the load effect compensation system of FIG. 1.

FIG. 3 is a block diagram illustrating a data correction unit included in the load effect compensation system of FIG. 1.

FIG. 4 illustrates a light sensor included in the load effect compensation system of FIG. 1.

FIGS. 5 and 6 illustrate examples of a light sensor attached to a display panel.

FIG. 7 is a block diagram illustrating a display device according to example embodiments.

FIG. 8 is a block diagram illustrating an electronic device having the display device of FIG. 7.

FIG. 9 is a diagram illustrating an example in which the electronic device of FIG. 8 is implemented as a smartphone.

FIG. 10 is a flowchart illustrating a method of compensating a load effect of a display panel according to the example embodiments.

FIG. 11 is a flowchart illustrating a method of detecting an amount of light employing the method of FIG. 10.

FIG. 12 is a flowchart illustrating a method of converting a detected amount of light into a load amount employing the method of FIG. 10.

### DETAILED DESCRIPTION OF CERTAIN INVENTIVE EMBODIMENTS

When a load amount of a flat panel display (FPD) increases, a problem known as a load effect can occur which causes the FPD to degrade. The load effect can be compensated by the following: storing a frame image signal, calculating the load amount of a frame image signal, and controlling a voltage or a current that is applied to the FPD based on the load amount.

Hereinafter, the described technology will be explained in detail with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

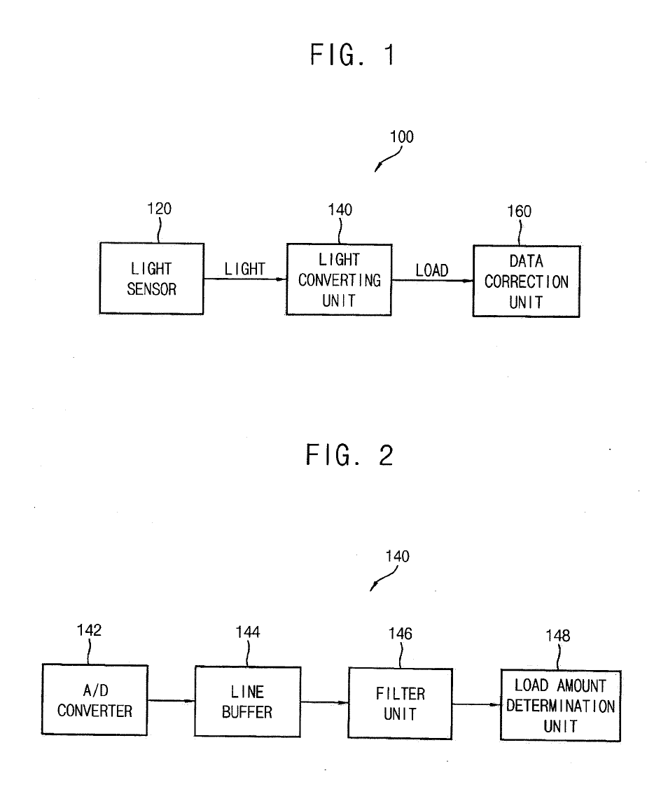

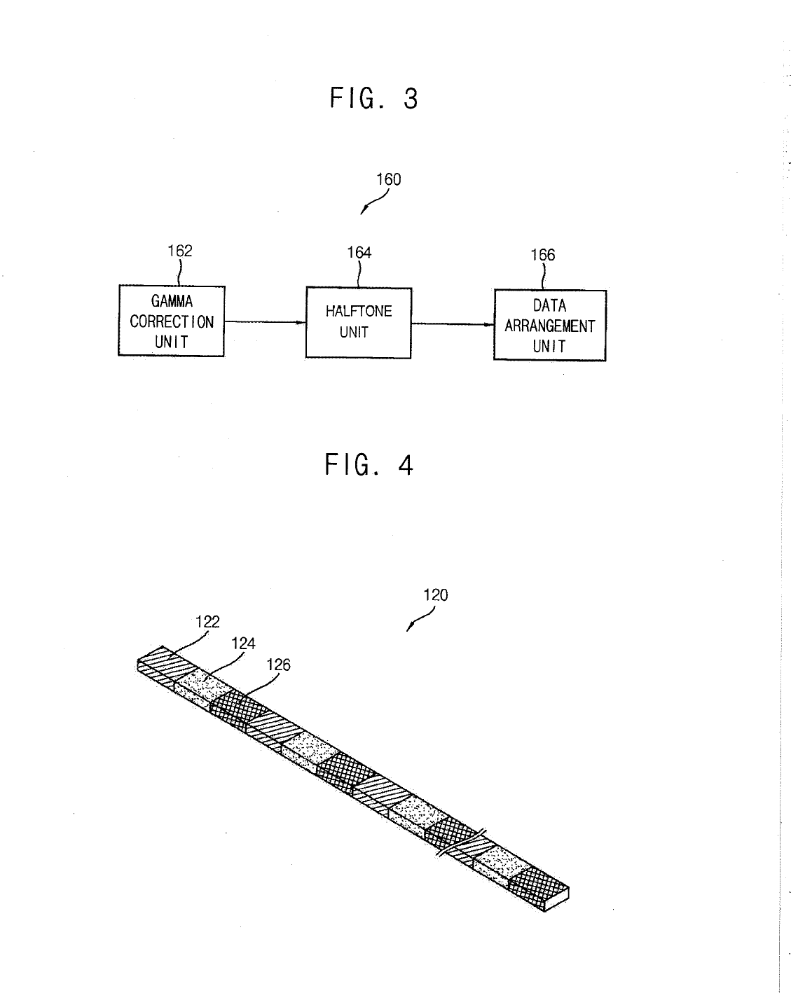

FIG. 1 is a block diagram illustrating a load effect compensation system according to example embodiments. FIG. 2 is a block diagram illustrating a light converting unit included in the load effect compensation system of FIG. 1. FIG. 3 is a block diagram illustrating a data correction unit included in the load effect compensation system of FIG. 1.

Referring to FIGS. 1 through 3, a load effect compensation system or load effect compensation system or load effect compensator 100 includes a light sensor 120, a light converting unit or light converter 140, and a data correction unit or data corrector 160.

The light sensor 120 is attached to a display panel. The light sensor 120 detects an amount of light that is emitted from the display panel. In some embodiments, the light sensor 120 is placed on a side of the display panel. In other embodiments, the light sensor 120 is placed on a back side of the display panel. The light sensor 120 can include a red light sensor, a green light sensor, and a blue light sensor. As such, the red light sensor detects red light emitted from the display panel and output an amount of red light as an analog value. For example, the red light sensor includes a red color filter. The green light sensor detects green light emitted from the display panel and output an amount of green light as an analog value. For example, the green light sensor includes a green color filter. The blue light sensor detects blue light emitted from the display panel and output an amount of blue light as an analog value. The amounts of light detected by the light sensor 120 are provided to the light converting unit 140.

The light converting unit 140 converts the amount of light detected by the light sensor 120 into a load amount. Referring to FIG. 2, the light converting unit 140 includes an analog-to-digital (A/D) converter 142, a line buffer 144, a filter 146, and a load amount determination unit 148. The A/D converter 142 converts the detected light into a digital signal. The A/D converter 142 receives the amount of light as an analog value and converts the analog value into a digital signal. The converted digital signal is within a range of a number of reference bits. For example, the digital conversion value is within a range of 10 bits. The line buffer 144 sequentially stores the digital signals. The filter unit 146 filters the digital signals stored in the line buffer 144. The amount of light can be changed (i.e. increased or decreased) due to internal and external conditions. The filter unit 146 can reduce errors that occur by the internal or external conditions by filtering the digital signals. For example, the filter unit is a mean filter or a median filter. The load amount determination unit 148 outputs the load amount corresponding to the digital signals filtered by the filter unit 146. The load amount determination unit 148 can store the load amount using a lookup table (LUT). The load amount determination unit 148 can select the load amount in the lookup table and provide the load amount to the data correction unit 160. It should be understood that the lookup table can be implemented by any storage device capable of storing the load amount corresponding to the digital signals.

The data correction unit 160 can receive the load amount and an image signal, and correct a grayscale value of the image signal based on the load amount. Referring to FIG. 3, the data correction unit 160 includes a gamma correction unit 162, a halftone unit 164, and a data arrangement unit 166. The gamma correction unit 162 can control a brightness of the image signal based on the load amount provided from the light converting unit 140. For example, when the load amount is increased, the gamma correction unit 162 decreases the brightness of the image signal. Alternatively, when the load amount decreases, the gamma correction unit 162 increases the brightness of the image signal. When the brightness (i.e. grayscale value) is changed, a gamma curve of the image signal can be distorted. The gamma correction unit 162 can adjust the distorted gamma curve. For example, the gamma correction unit 162 adjusts the grayscale value of the image signal to have a 2.2 gamma curve. The halftone unit 164 can prevent a signal distortion by reflecting decimal place of the adjusted image signal to the next image signal using an error diffusion (E/D) or a dithering. The data arrangement unit 166 can rearrange a format of the image signal to fit an output terminal. The image signal that is rearranged can be stored in a memory or can be delivered to the output terminal. Although the data correction unit 160 that includes the gamma correction unit 162, the halftone unit 164, and the data arrangement unit 166 is described above, the data correction unit 160 is not limited thereto. For example, in some embodiments, the data correction unit 160 does not include the halftone unit 164.

Typical image-conversion techniques store the image signal for every frame and calculate the load amount. According to some embodiments, the load effect compensation system 100 decreases the amount of memory required by converting the amount of light emitted from the display panel into the load amount. Further, an image with the load effect compensated can be displayed by controlling the brightness of the image based on the load amount and adjusting the grayscale value of the image signal.

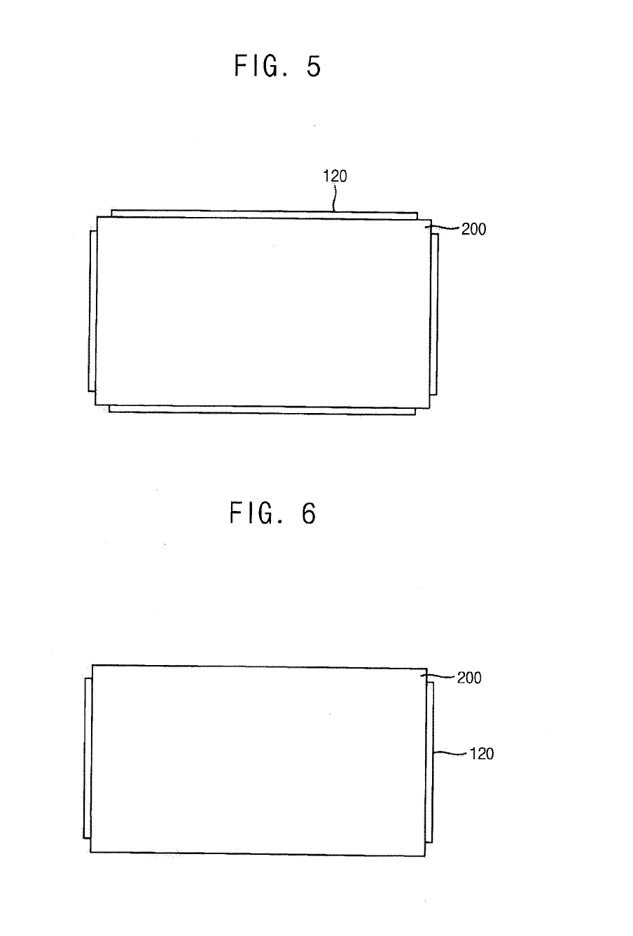

FIG. 4 illustrates a light sensor included in the load effect compensation system of FIG. 1. FIGS. 5 and 6 illustrate light sensors attached to a display panel.

Referring to FIGS. 4 through 6, the light sensor 120 include a red light sensor 122, a green light sensor 124, and a blue light sensor 126. The red light sensor 122 detects red light emitted from a display panel 200 and outputs the amount of red light as an analog value. For example, the red light sensor 122 includes a red color filter. The green light sensor 124 detects green light from emitted the display panel 200 and outputs the amount of green light as the analog value. For example, the green light sensor 124 includes a green color filter. The blue light sensor 126 detects blue light emitted from the display panel 200 and outputs the amount of blue light as the analog value. For example, the blue light sensor 126 includes a blue color filter. Although the light sensor 120 that includes the red light sensor 122, the green light sensor 124, and the blue light sensor 126 is illustrated in the FIG. 4, the light sensor 120 is not limited thereto. For example, the light sensor 120 can include a yellow light sensor and a blue light sensor. Although, the red light sensor 122, the green light sensor 124, and the blue light sensor 126 are attached to one another in FIG. 4, the red, green and blue light sensors 122, 124 and 126 can be arranged apart from each other. In some embodiments, the light sensor 120 further includes a sensor board to arrange the red, green and blue light sensors 122, 124 and 126.

As illustrated in FIG. 5, the light sensor 120 is arranged on each of the four sides of the display panel 200. As illustrated in FIG. 6, the light sensor 120 is arranged on two sides of the display panel 200. Although the light sensors 120 are arranged on the left and right sides of the display panel 200 in FIG. 6, the light sensors 120 can be arranged on the top and bottom sides of the display panel 200. In some embodiments, the light sensor 120 is placed on a back side of the display panel 200. The amount of light detected by the light sensor 120 is provided to the light converting unit 140.

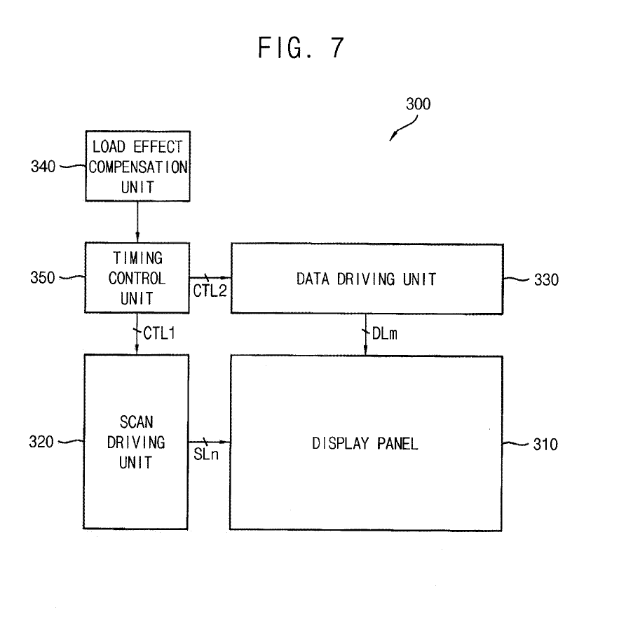

FIG. 7 is a block diagram illustrating a display device according to example embodiments.

Referring to FIG. 7, a display device 300 includes a display panel 310, a scan driving unit or scan driver 320, a data driving unit or data driver 330, a load effect compensation system 340, and a timing control unit or timing controller 350. Here, the load effect compensation system 340 corresponds to the load effect compensation system 100 of FIG. 1.

The display panel 310 includes a plurality of pixels. Each pixel can include an organic light-emitting diode (OLED). In some embodiment, each pixel includes a pixel circuit, a driving transistor, and an OLED. A data signal is provided via data lines DLm. The pixel circuit transmits the data signal to the driving transistor based on a scan signal provided via scan-lines SLn. The driving transistor can control current flowing through the OLED based on the data signal, and the OLED emits light based on the current. The scan driving unit 320 provides the scan signal to the pixels via the scan-lines SLn. The data driving unit 330 provides the data signal to the pixels via the data-lines DLm. Although, the load effect compensation system 340 is connected to the timing control unit 350 in FIG. 7, the load effect compensation system 340 can be located in the timing control unit 350.

The timing control unit 350 can control the scan driving unit 320, the data driving unit 330, and the load effect compensation system 340 by generating a plurality of control signals CTL1 and CTL2.

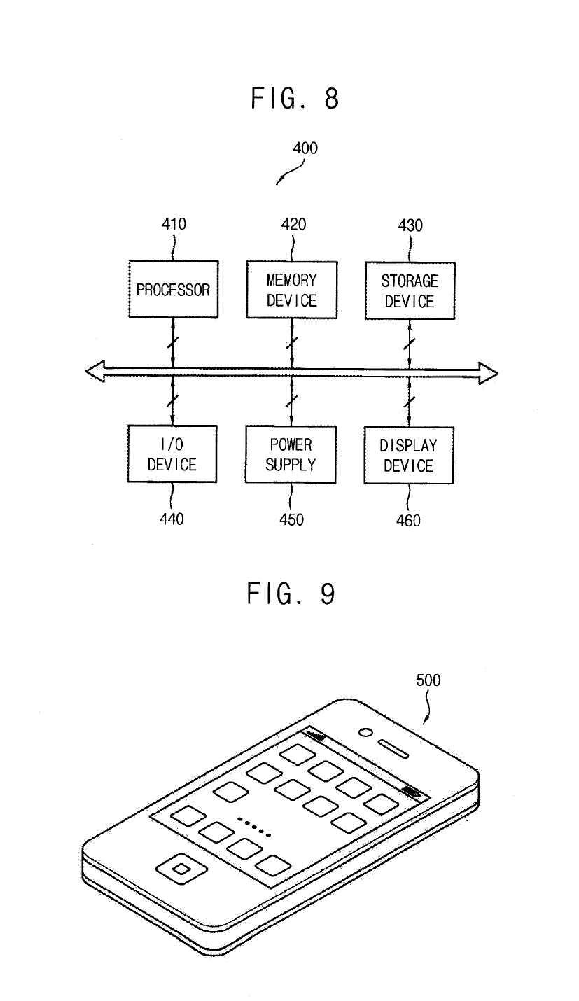

FIG. 8 is a block diagram illustrating an electronic device having the display device 300 of FIG. 7. FIG. 9 is a diagram illustrating an example in which the electronic device of FIG. 8 is implemented as a smart-phone.

Referring to FIGS. 8 and 9, the electronic device 400 includes a processor 410, a memory device 420, a storage device 430, an input/output (I/O) device 440, a power supply 450 and a display device 460. Here, the display device 460 corresponds to the display device 300 of FIG. 7, but is not limited thereto. In addition, the electronic device 400 can further include a plurality of ports for communicating a video card, a sound card, a memory card, a universal serial bus (USB) device, other electronic device, etc. Although it is illustrated in FIG. 9 that the electronic device 400 is implemented as a smartphone 500, it is not limited thereto.

The processor 410 can perform various computing functions. The processor 410 can be a microprocessor, a central processing unit (CPU), etc. The processor 410 can be coupled to other components via an address bus, a control bus, a data bus, etc. Further, the processor 410 can be coupled to an extended bus such as peripheral component interconnect (PCI) bus. The memory device 420 can store data for operations of the electronic device 600. For example, the memory device 420 can include at least one non-volatile memory device such as an erasable programmable read-only memory (EPROM) device, an electrically erasable programmable read-only memory (EEPROM) device, a flash memory device, a phase-change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc. The storage device 430 can be a solid state drive (SSD) device, a hard disk drive (HDD) device, a CD-ROM device, etc.

The I/O device 440 can be an input device such as a keyboard, a keypad, a touchpad, a touch-screen, a mouse, etc., and an output device such as a printer, a speaker, etc. In some embodiments, the display device 460 is included in the I/O device 440. The power supply 450 can provide a power for operating the electronic device 400. The display device 460 can communicate with other components via the buses or other communication links. As described above, the display device 460 can include the load effect compensation system 100. As described, the electronic device 400 of FIG. 8 can include the display device 460 that includes the load effect compensation system. The display device 460 that includes the load effect compensation system 100 can decrease the amount of memory required by converting the amount of light emitted from the display panel into the load amount. Further, an image with the load effect compensated can be displayed by controlling the brightness of the image based on the load amount and adjusting the grayscale value of the image signal.

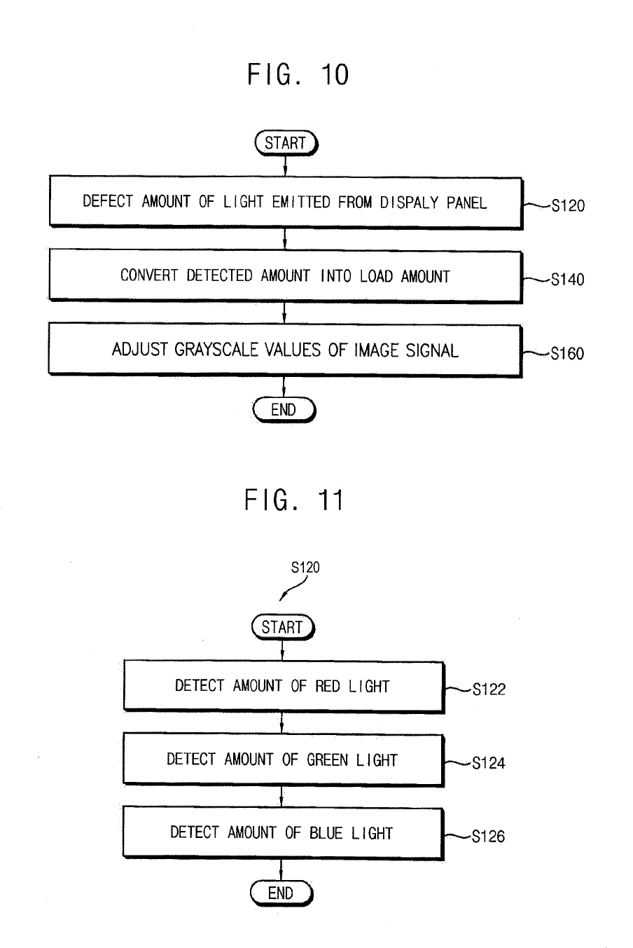

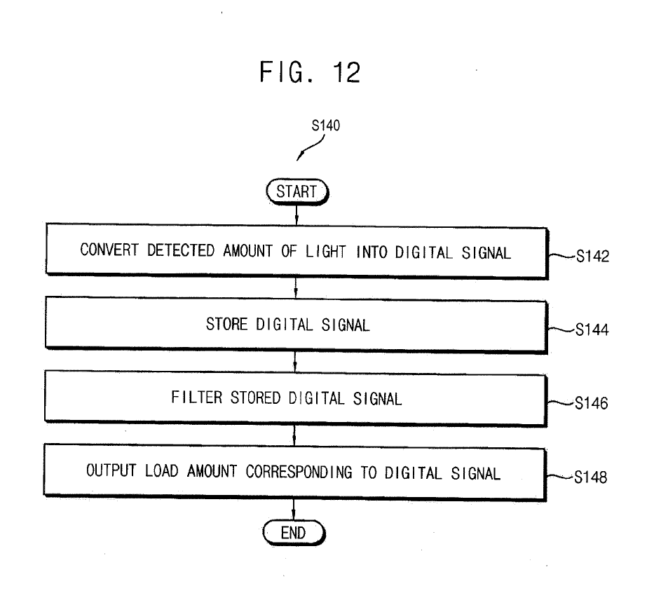

FIG. 10 is a flowchart illustrating a method of compensating a load effect of a display panel according to the example embodiments. FIG. 11 is a flowchart illustrating a method of detecting an amount of light employing the method of FIG. 10. FIG. 12 is a flowchart illustrating a method of converting a detected amount of light into a load amount employing the method of FIG. 10.

In some embodiments, the FIG. 10 procedure is implemented in a conventional programming language, such as C or C++ or another suitable programming language. The program can be stored on a computer accessible storage medium of the load effect compensation system 100, for example, a memory (not shown) of the load compensation 100 or the display device 300. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 10. The description of this paragraph applies to the embodiments shown in FIGS. 11-12.

Referring to FIG. 10, a method of compensating the load effect of the display panel 200 is shown. The method includes detecting the amount of light emitted from a display panel 200 using a light sensor 120 (S120). The method also includes converting the detected amount of light into a load amount (S140). Furthermore, the method includes adjusting a grayscale value of an image signal based on the load amount (S160).

Referring to FIG. 11, the detecting the amount of light emitted from a display panel of FIG. 10 (S120) includes the following steps. The method includes detecting an amount of red light emitted from the display panel 200 (S122), detecting an amount of green light emitted from the display panel 200 (S124), and detecting an amount of blue light emitted from the display panel 200 (S126). The light sensor 120 outputs the amount of light emitted from the display panel as an analog value.

Referring to FIG. 12, the converting the detected amount of light into the load amount (S140) of FIG. 10 includes converting the detected amount of light into the digital signal (S142) and storing the digital signal (S144). And the converting also includes filtering the stored digital signal (S146) and outputting the load amount corresponding to filtered digital signal (S148). The digital signal that is converted by the A/D converter can be sequentially stored in a line buffer and the stored digital signal can be filtered by the filter unit. The filter unit can decrease an error occurred due to internal and external conditions by filtering the digital signals. For example, the filter unit is a mean filter or median filter. The method of converting the amount of light into the load amount of FIG. 12 includes outputting the load amount corresponding to the filtered digital signal (S148). The load amount can be determined by the load amount determination unit 148. The load amount determination unit stores the load amount corresponding to the digital signals using a lookup table (LUT). The load amount determination unit can select the load amount corresponding to the digital signal in the lookup table and provide the load amount to the data correction unit.

As described above, the method of FIG. 10 adjusts a grayscale value of an image signal based on the load amount (S160). The image signal can be adjusted or corrected by a data correction unit 160. The data correction unit 160 can control the brightness of the image and correct or adjust the image signal according to the brightness of the image. For example, the data correction unit can include the gamma correction unit 162 and the halftone unit 164. The gamma correction unit can correct a distorted gamma curve when the brightness (i.e. grayscale value) of the image signal is changed. The halftone unit 164 can prevent a signal distortion using an E/D (Error Diffusion) or a dithering. The corrected image signal can be rearranged and stored in the memory or provided to an output terminal.

The described technology can be applied to an electronic device having a display device. For example, the described technology can be applied to a computer monitor, a laptop, a digital camera, a cellular phone, a smartphone, a tablet personal computer (PC), a television, a personal digital assistant (PDA), a portable multimedia player (PMP), an MP3 player, a navigation system, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A load effect compensation system for a display device comprising:
a light sensor operatively connected to a display panel and configured to detect an amount of light emitted from the display panel;
a light converter configured to convert the detected amount of light into a load amount; and
a data corrector configured to i) receive the load amount and an image signal, and ii) adjust grayscale values of the image signal based at least in part on the load amount.

2. The load effect compensation system of claim 1, wherein the light converter includes:
an analog-to-digital (A/D) converter configured to convert the detected amount of light into a digital signal;
a line buffer configured to store the digital signal;
a filter configured to filter the stored digital signal; and
a load amount determination unit configured to determine the load amount based at least in part on the filtered digital signal.

3. The load effect compensation system of claim 2, wherein the load amount determination unit is further configured to determine the load amount based at least in part on a lookup table that stores the load amount corresponding to the digital signal.

4. The load effect compensation system of claim 1, wherein the light sensor is placed on a side of the display panel.

5. The load effect compensation system of claim 1, wherein the light sensor is placed on a back surface of the display panel.

6. The load effect compensation system of claim 1, wherein the light sensor includes:
red, green and blue light sensors respectively configured to detect amounts of red, green and blue light.

7. The load effect compensation system of claim 6, wherein the red, green and blue light sensors respectively include red, green and blue color filters.

8. A display device comprising:
a display panel configured to emit light;
a scan driver configured to transmit a scan signal to the display panel;
a data driver configured to transmit a data signal to the display panel;
a load effect compensation system configured to i) detect an amount of the emitted light, ii) convert the detected amount of light into a load amount, and iii) adjust grayscale values of an image signal based at least in part on the load amount; and
a timing controller configured to control the scan driver, the data driver, and the load effect compensation system.

9. The display device of claim 8, wherein the load effect compensation system is connected to or located in the timing controller.

10. The display device of claim 8, wherein the load effect compensation system includes:
a light sensor attached to the display panel and configured to detect the amount of emitted light;
a light converter configured to convert the detected amount of light into the load amount; and
a data corrector configured to i) receive the load amount and the image signal and ii) adjust grayscale values of the image signal based at least in part on the load amount.

11. The display device of claim 10, wherein the light converter includes:
an analog-to-digital (A/D) converter configured to convert the detected amount of light into a digital signal;
a line buffer configured to store the digital signal;
a filter configured to filter the stored digital signal; and
a load amount determination unit configured to determine and output the load amount based at least in part on the filtered digital signal.

12. The display device of claim 11, wherein the load amount determination unit is configured to determine the load amount based at least in part on a lookup table that stores the load amount corresponding to the digital signal.

13. The display device of claim 10, wherein the light sensor is placed on a side of the display panel.

14. The display device of claim 10, wherein the light sensor is placed on a back surface of the display panel.

15. The display device of claim 10, wherein the light sensor includes:
red, green and blue light sensors respectively configured to detect amounts of red, green and blue light.

16. The display device of claim 15, wherein the red, green and blue light sensors respectively include red, green and blue color filters.

17. A method of compensating a load effect for a display panel, the method comprising:
detecting an amount of light emitted from the display panel;
converting the detected amount of light into a load amount; and
adjusting grayscale values of an image signal based at least in part on the load amount.

18. The method of claim 17, wherein the converting includes:
converting the detected amount of light into a digital signal;
storing the digital signal;
filtering the stored digital signal; and
determining the load amount based at least in part on the filtered digital signal.

19. The method of claim 18, wherein the determining is performed based at least in part on a lookup table that stores the load amount corresponding to the digital signal.

20. The method of claim 15, wherein the detecting includes:
detecting amounts of red, green and blue light emitted from the display panel.
